(19) United States
(12) Patent Application Publication
(10) Pub. No.: US 2023/0013495 A1
(43) Pub. Date: Jan. 19, 2023

(54) A DOUBLE-SIDE PRINTABLE PSA THERMAL LABEL

(71) Applicant: UPM RAFLATAC OY, TAMPERE (FI)

(72) Inventor: Juha KIVIMÄKI, TAMPERE (FI)

(21) Appl. No.: 17/783,122

(22) PCT Filed: Dec. 20, 2019
(86) PCT No.: PCT/FI2019/050918

§ 371 Date: Jun. 7, 2022

(51) Int. Cl. C09J 7/29; C09J 7/38; B31D 1/02; B41M 5/30; B41M 5/41; G09F 3/00

(52) U.S. Cl. CPC C09J 7/29; B31D 1/021; B41M 5/30; B41M 5/41; C09J 7/385; G09F 3/0297; B31D 2201/02; B41M 2205/04; B41M 2205/36; C09J 2203/334; C09J 2301/41; C09J 2301/124; C09J 2400/283; C09J 2433/00; G09F 2003/0241

(57) ABSTRACT

The invention relates to a double-side printable label suitable for machine readable labelling of food containers and a method for manufacturing such label, wherein the label is arranged to comprise a base paper made of chemical pulp that separates the face and reverse sides, the face side comprising a layer of temperature sensitive coating which free of bisphenol A and suitable for direct thermal printing, the reverse side comprising a layer of pressure sensitive adhesive, which is suitable for flexographic printing with ultraviolet curable inks, and wherein the machine readability of the label is improved by means of the pressure sensitive adhesive layer thickness having effect on the static sensitivity of the temperature sensitive coating of the label.

### TECHNICAL FIELD

The invention relates to a double-side printable and pressure-sensitive adhesive thermal label which is suitable for use in labelling of food containers and to a method for manufacturing such label.

### BACKGROUND

2,2-bis(p-hydroxyphenyl)propane, also known as Bisphenol A, hereafter also referred to as BPA, is a widely used developer in a number of thermal paper applications, and also in thermal labels. Tightening legislative initiatives, such as EC 2016/2235, however, are imposing restrictions on the use of BPA. Therefore, novel thermal papers and thermal labels without BPA needs to be developed. While another type of bisphenolic or phenolic or even a urea based color developer may be used as a replacement for BPA in thermal paper, the lack of BPA poses unexpected challenges in thermal labels. In particular, the lack of BPA in the temperature sensitive coating layer has been observed to cause a specific problem on the double side printability of a PSA thermal label which is to be suitable for use in labelling of food containers. This problem becomes evident when the label has been printed from both sides, such that also the face side contains a direct thermal print. The replacement of BPA with another color developer may lead to appearance of an excess print on the face side, which can degrade the machine readability of the face side of the label. Machine readability refers to automated computer-aided detection of product specific data, which is an established practice in the food packaging industry.

Reference is made to FIGS. 1a to 1c, which illustrate the problem. A double-side printable PSA thermal label LAB1 is typically used as an information carrier in consumer products that are intended to come into contact with food. Prior to adhering the thermal label on a product surface, which may be transparent, one or both sides of the thermal label may be printed. When the product surface is transparent, the benefit of providing a print on the reverse side is that the print is visible through the product surface. Each side of the label may thus be subjected to different printing techniques. The reverse side BLR1 of the label LAB1 typically contains general information, denoted by a mark MRK1. The general information is typically static and can be, for example a recipe, an advertisement or a trademark formed of symbols, characters and/or text. The purpose of the mark MRK1 on the reverse side of the thermal label LAB1 is thus to present visually readable information to a person. In case of a container sealed by a transparent filmic cover, the mark MRK1 may be viewed after the container has been opened. A typical printing technique for providing the mark MRK1 is UV flexographic printing, hereafter also referred to as flexographic printing made with UV light curable printing ink, which does not require solvent drying. UV flexographic printing refers to a method wherein ultraviolet light curable ink is applied on the reverse side of the label and subsequently cured by radiation on UV light wavelengths. UV light curable printing inks typically contain 1.5 to 2 times more pigments than solvent-based or water-based inks.

The face side FLR1 of the label LAB1 is typically arranged to contain product specific data MRK2, which may vary between each labelled product. Product specific data MRK2 may be, for example, logistic information, price and/or weight of the product containing the label. Product specific data MRK2 is often compressed into machine readable format. Examples of machine readable formats are bar codes, such as linear and/or two dimensional bar code formats, for example EAN bar code or QR code. The printing of the face side is often performed separately from the reverse side. The printing of the face side may be part of a high-speed labelling operation, whereby a fast and reliable printing method, such as direct thermal printing, is required. In case of a container sealed by a transparent filmic cover, the product specific data MRK2 is typically read by a machine before the container is opened. The purpose of mark MRK1 on the face side thus differs from the product specific data MRK2 on the reverse side of the thermal label, the face side being a machine readable data carrier.

Reference is made to FIG. 1c. A particular problem associated to replacement of BPA by another color developer is the behavior of a flexographic print that has been printed with UV curable ink on the reverse side BLR1 of the thermal label. In a thermal label without BPA, a mirror mark MRK3 of the flexographic print on the reverse side BLR1 of the thermal label may become visible on the face side FLR1 of the thermal label LAB1, despite the presence of a barrier layer and a precoat layer, which may be used to prevent adhesive migration and to insulate the temperature sensitive coating on the face side FLR1, respectively. The mirror mark MRK3 becomes prominent once the label has been subjected to a direct thermal printing. The at least partial appearance of such a mirror image of the flexographic print on the face side of the thermal label is problematic for the machine readability of the label, since the mirror mark MRK3 may overlap with the product specific data MRK2, which leads to reflection difference degradation between light and dark elements of the product specific data. In case of bar codes, the reflection difference is typically referred to as print contrast signal or PCS. If the reflection difference is not sufficiently high, the product specific data MRK2 may not be machine readable reliably or not at all.

### SUMMARY

The scope of protection sought for various examples of the invention is set out by the independent claims. The examples and features, if any, described in this specification that do not fall under the scope of the independent claims are to be interpreted as examples useful for understanding the invention.

Thermal paper, as disclosed herein, refers to a special type of printable paper, which contains a layer of temperature sensitive coating that has been configured to change color, when exposed to a specified amount of heat. Thermal paper typically begins to change color at a temperature in the range of 60 to 100° C. The change of color is due to the presence of a leuco dye, which is colorless at room temperature, but undergoes a structural change when protonated in the presence of sufficient heat and a proton donor, thereby producing a colored structure. The proton donor is typically referred to as a color developer, developing agent or simply as a developer.

A thermal label may be produced of a thermal paper. Reference is made to FIG. 2, which illustrates, by way of an example, a cross-sectional view of a double-side printable label LAB1 comprising a base paper PAP1 separating a face side FLR1 comprising a layer of temperature sensitive coating LEU1 suitable for direct thermal printing and a reverse side BLR1 comprising a layer of pressure sensitive adhesive ADH1 having a thickness Hₐ, which has been adhered on a product surface S_{OBJ}.

A thermal label, as disclosed herein, thus refers to a printable multi-layer label which contains a layer of pressure-sensitive adhesive on a reverse side that is suitable for adhering the thermally printable label on a product surface and a face side which contains a layer of temperature sensitive coating suitable for direct thermal printing. The face side of a thermal label, prior to printing, is typically white. The CIE whiteness of the face side may be determined by a standardized method (ISO 11475), which is based on reflectance data obtained over the full visible light spectral range. Direct thermal printing refers to a process wherein a thermal printing head is configured to heat a predefined region of the face side of the label such that the temperature sensitive coating within said predefined region is protonated and produces the colored structure. The colored structure is most often black, but other colors are possible. The developed color depends of the composition of the temperature sensitive coating. A pressure sensitive adhesive is hereafter denoted as PSA. A thermal label which contains a layer of PSA may be attached to a product surface by applying light pressure. A double-side printable thermal label in this context further contains a reverse side that is suitable for flexographic printing with UV light curable printing ink.

The invention disclosed herein solves the above-mentioned problem related to flexographic print behaviour by providing a BPA free, double-side printable and pressure-sensitive adhesive thermal label, which comprises a base paper made of chemical pulp that separates a face side suitable for direct thermal printing and a reverse side suitable for flexographic printing with UV light curable printing inks, containing a layer pressure sensitive adhesive. BPA typically used in the layer of temperature sensitive coating has been replaced by an alternative color developer, preferably by another type of bisphenolic color developer. The pressure sensitive adhesive, preferably a water-based acrylic adhesive, has been selected to be suitable for labelling of food containers. The combination of an alternative color developer to BPA and a layer of pressure sensitive adhesive provides means to adjust the double side printability of the thermal label, such that the reverse side of the label has better retention capability for flexographic printing.

In the past, thermosensitivity of a thermal paper has typically been adjusted by means of calendering and precoating the base paper, prior to application of a temperature sensitive coating, or by means of sensitizing agents within the temperature sensitive coating. However, with respect to thermal labels comprising BPA free temperature sensitive coatings, empirical studies indicate that pressure sensitive adhesives suitable for labelling of food containers may be used to provide a double side printable thermal label, wherein the appearance of a reverse side print on the layer of temperature sensitive coating on the face side is avoidable. Results obtained of BPA free thermal papers and labels surprisingly indicate that a layer of PSA applied on the reverse side of the label may be used to prevent a flexographic print made with UV light curable printing ink from interacting with a temperature sensitive coating on the face side of the label. By selecting the composition and/or the thickness of the pressure sensitive adhesive layer, the interaction with the temperature sensitive coating may be further reduced. The double-side printability of such thermal labels may be determined by measuring static thermosensitivity of the label, in accordance with standard ISO 5-4:2009(E). The suitability of a base paper comprising a layer of temperature sensitive coating for double-side printable thermal labels may further be determined by measuring static thermosensitivity of the base paper comprising the layer of temperature sensitive coating from both sides, in accordance with standard ISO 5-4:2009(E). Static thermosensitivity indicates the relationship between temperature and the change of color which takes place when the leuco dye reacts with the alternative color developer. Static thermosensitivity may be expressed as optical density at a defined temperature, which refers to the portion of incident light reflected by the face side of the label. The optical density of a base paper comprising a layer of temperature sensitive coating at a defined temperature may be determined from each side, i.e. the face side and/or the reverse side. Of particular notice is, that results of an experimental study indicate that a thermal paper suitability for use in a double side printable label may correlate with the arithmetic mean optical density of the thermal paper. A suitable base paper comprising a layer of temperature sensitive coating, after 2 seconds of exposure at a temperature of 80° C. or 95° C., has an optical density of less than 0.1, when measured as an arithmetic mean of three measurements with 45°/0° ring illumination optics, both from the reverse side and the face side of the base paper. Advantageously, the base paper comprising a layer of temperature sensitive coating has a different optical density on the reverse side and the face side, such that the portion of incident light reflected by the reverse side of the base paper label is less than the portion of incident light reflected by the face side of the base paper label comprising the layer of temperature sensitive coating.

Pressure sensitive adhesive layer on the reverse side provides a means to control the properties of the label, such that the appearance of a reverse side print on the layer of temperature sensitive coating on the face side is avoidable. Experimental results indicate that the PSA layer may be arranged to provide lower static thermosensitivity on the reverse side of the label. A lower static thermosensitivity on the reverse side of the label has been observed to correlate with reduced tendency of a mirror image of a flexographic print made with UV light curable printing ink appearing on the face side of the thermal label. This has an impact on the machine readability of the label. Based on experimental results, a PSA thermal label as disclosed herein, having optical density of less than 0.1, when determined from face side of the label as an arithmetic mean of three measurements with 45°/0° ring illumination optics, after 2 seconds of exposure at a temperature of 80° C., in accordance with standard ISO 5-4:2009, is double-side printable such that a flexographic print made with UV light curable printing ink on the reverse side does not interfere with the machine readability of the face side of the label. A low static thermosensitivity, when determined at a higher temperature, correlates with improved machine readability. Advantageously the optical density is also less than 0.7, when determined from face side of the label as an arithmetic mean of three measurements with 45°/0° ring illumination optics, after 2 seconds of exposure at a temperature of 95° C., in accordance with standard ISO 5-4:2009(E). A double-side printable thermal label that is machine readable is capable to provide a minimum print contrast signal of equal to or above 80%, when determined by means of direct thermal printing of a ladder bar code, in accordance with the standard ISO / IEC 15416:2016(E).

Food packaging is a specific industrial field, which uses a large amount of thermal labels on transparent filmic surfaces and packages. Transparent films are advantageous for providing the user a view of the contents inside the package. A thermal label may be used to provide various information and quality assurance of the product. The proximity to food limits the group of pressure sensitive adhesives that may be used on the label. PSA suitable for food packaging needs to be approved for such use. The layer of pressure sensitive adhesive may be selected from a group of water-based acrylic adhesives or a hotmelt adhesives that are suitable for use in labelling of food containers. Preferably, the layer of PSA is of water-based acrylic adhesive, which includes acrylic polymer(s) and tackifying resin(s), such as rosin ester resins. Water-based acrylic adhesives suitable for use in labelling of food containers have been observed to further improve the double-side printability of the thermal label, in particular when used in combination with a temperature sensitive coating containing bisphenolic developer. Water-based acrylic adhesives may be used to reduce thermosensitivity of the reverse side. Based on surface free energy results obtained from experimental studies, water-based acrylic adhesives have a low surface energy level. The water-based acrylic adhesive therefore may have improved barrier effect towards UV light curable printing inks, which typically contain higher amounts of pigments. When the layer of pressure sensitive adhesive is of a water-based acrylic adhesive, the layer may therefore possess a better retention capability of UV light curable printing inks. In other words, a PSA layer of water-based acrylic adhesive may be arranged to reduce the migration of UV light curable printing inks towards the face side of the label. When the layer of PSA is of water-based acrylic adhesive, static thermosensitivity of the face side of the label may therefore be adjusted. The water-based acrylic adhesives further appear to enhance the insulation of the reverse side of the thermal label and thereby effectively resist the propagation of a flexographic print made with UV light curable printing ink on the layer of PSA. Advantageously, the layer of PSA is permanent adhesive having a loop tack value which is equal to or higher than 10 Newton, when measured according to FINAT test method no. 9 (9th edition, 2009). Advantageously, the PSA layer thickness is in the range of 10 to 20 micrometres. This thickness range is most advantageous for controlling the thermosensitive properties of the label.

The properties of the label may be further adjusted by means of a base paper, which separates the face side and the reverse side of the label. A base paper made of chemical pulp has a very high cellulose fibre content and thereby excellent physical properties, such as stiffness and rigidity. Advantageously, the label comprises a base paper made of bleached chemical pulp, which typically contains lignin in an amount of less than 1 wt.%. Bleaching of chemical pulp decreases considerably the amounts of hemicelluloses, lignin, wood extractives and inorganics in the material. Thereby a label with enhanced surface whiteness and brightness may be produced, since typically, prior to direct thermal printing, the layers on the face side of the thermal label comprise transparency, at least to some extent. Advantageously the face side of the label, prior to direct thermal printing, has a ISO whiteness equal to or above 105%, preferably equal to or above 120%, most preferably equal to or above 130%, when determined in accordance with ISO 11475. By providing a label with a high surface whiteness level, the reflection difference of dark elements and light elements of a thermal print may be increased. This improves the print contrast signal of the label and thereby the machine readability of the product specific data.

A double-side printable label may also comprise further layers, such as a transparent coating layer on top of the temperature sensitive coating as an outermost layer of the face side. The coating layer typically comprises or consists of water-soluble starch, carboxylmethylcellulose, partially or fully hydrolyzed polyvinyl alcohol or a derivative thereof and serves to protect the layer of temperature sensitive coating.

Accordingly, there is provided a double-side printable label suitable for machine readable labelling of food containers, the label comprising
a base paper made of chemical pulp that separates
   a face side suitable for direct thermal printing and
   a reverse side,
the reverse side comprising a layer of pressure sensitive adhesive, which layer is suitable for flexographic printing with ultraviolet curable inks, and,
the face side comprising a layer of temperature sensitive coating which is free of 2,2-bis(p-hydroxyphenyl)propane and
, wherein the pressure sensitive adhesive layer thickness has been selected such that the portion of incident light reflected by the face side of the label, when expressed as optical density, is less than 0.1, when determined as an arithmetic mean of three measurements with 45°/0° ring illumination optics, after 2 seconds of exposure at a temperature of 80° C., in accordance with standard ISO 5-4:2009(E).

Correspondingly, there is provided a method for manufacturing a double-side printable label suitable for machine readable labelling of food containers, the method comprising
providing a base paper made of chemical pulp, which comprises a temperature sensitive coating which is free of 2,2-bis(p-hydroxyphenyl)propane and a priming layer between the base paper layer and the temperature sensitive coating on a first side of the base paper thereby obtaining a face side suitable for direct thermal printing, and
coating pressure sensitive adhesive which is suitable for UV flexographic printing onto the other side of the base paper, thereby obtaining a reverse side comprising a layer of pressure sensitive adhesive
, wherein the method, the thickness of the layer of pressure sensitive adhesive is selected such that the portion of incident light reflected by the face side of the label, when expressed as optical density, is less than 0.1, when determined as an arithmetic mean of three measurements with 45°/0° ring illumination optics, after 2 seconds of exposure at a temperature of 80° C., in accordance with standard ISO 5-4:2009(E).

Hereafter, working examples useful for understanding the invention will be described in more detail.

### BRIEF DESCRIPTION OF THE DRAWINGS

FIG. 1a illustrates, by way of an example, a flexographic print that has been printed with ultraviolet light curable ink on a reverse side of a thermal label.

FIG. 1b illustrates, by way of an example, a direct thermal print that has been printed on a face side of a thermal label.

FIG. 1c illustrates, by way of an example, a face side of a BPA free thermal label, wherein a flexographic print that has been printed with ultraviolet light curable ink on the reverse side of the thermal label has become visible on the temperature sensitive coating on the face side and overlaps with a direct thermal print.

FIG. 2 illustrates, by way of an example, a cross-sectional view of a double-side printable label comprising a base paper separating a face side comprising a layer of temperature sensitive coating suitable for direct thermal printing and a reverse side comprising a layer of pressure sensitive adhesive, which has been adhered on an object surface.

FIG. 3 illustrates, by way of an example, a cross-sectional view of a double-side printable label comprising a base paper separating a face side comprising a layer of temperature sensitive coating suitable for direct thermal printing and a reverse side comprising a layer of pressure sensitive adhesive, further comprising a barrier layer between the base paper layer and the pressure sensitive adhesive layer, a precoating layer between the base paper and the temperature sensitive coating and a coating layer on top of the temperature sensitive coating as an outermost layer of the face side.

FIG. 4 illustrates the results of an experimental study investigating the static thermosensitivity of double-side printable labels.

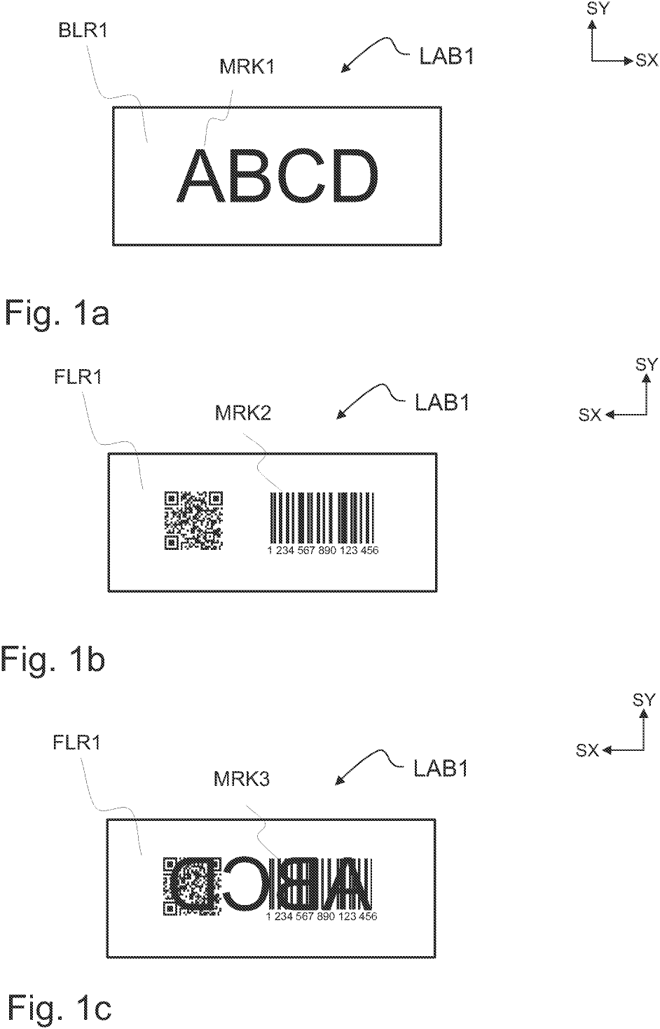

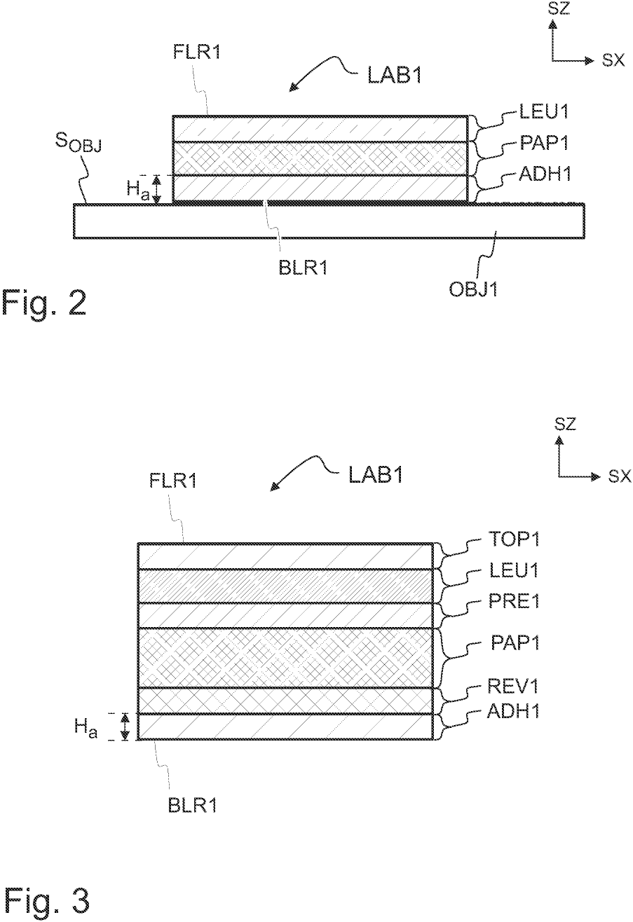

FIGS. 1a, 1b, 1c, 2 and 3 are schematic and not in any particular scale. The symbols SX, SY and SZ in the figures refer to orthogonal directions which are perpendicular to each other.

### DETAILED DESCRIPTION

### A Double-Side Printable Adhesive Label

A label typically comprises a face layer and an adhesive layer for attaching the face layer to an item. A label is therefore a multi-layer product having a face side and a reverse side comprising the adhesive layer, wherein the reverse side is intended to be adhered on a surface of a product. A label maybe used to display information. A double side printable label comprises a first side and a second side, wherein both sides of the label may be separately printed. A double-side printable adhesive label further comprises a layer of adhesive material. An adhesive refers to a composition which has a tendency to adhere towards an object surface by means of chemical adhesion or dispersive adhesion. Adhesion of an adhesive depends on the type of the adhesive and the used surface material. The strength of the adhesive may increase after the label has been attached to the product surface.

Properties of a label may be determined by using standardized test methods, such as described in the FINAT technical handbook comprising test methods for self-adhesive materials (9th edition, year 2014). Numerical values characterizing the properties of a label refer to values obtained by FINAT methods, unless otherwise specified.

The thickness of a layer of PSA may be determined according to ISO standard 534.

### A Method for Manufacturing a Double-Side Printable Label

Reference is made to FIG. 3. A double-side printable label LAB1 may be manufactured of a thermal paper. A thermal paper may be produced of a base paper PAP1, which is coated with a layer of temperature sensitive coating LEU1. Optionally, other layers, such as a pre-coat layer PRE1, a coating layer TOP1 on top of the temperature sensitive coating LEU1 and/or a barrier layer REV1 may be provided. A double-side printable thermal label LAB1 comprises, in addition, at least a layer of pressure sensitive adhesive ADH1. The layer of pressure sensitive adhesive ADH1 may be applied on the reverse side BLR1 of the label LAB1. The pressure sensitive adhesive ADH1 may be applied as a coating, such as contour type coating, spray or curtain coating, a film transfer coating, or blade/ rod coating. A double-side printable thermal label LAB1 typically has a basis weight in the range of 60 to 90 g/m², preferably in the range of 62 to 80 g/m², most preferably in the range of 63 to 75 g/m².

A double-side printable thermal label LAB1 may be manufactured from a facestock, for example by die cutting a facestock. A method for manufacturing a double-side printable label LAB1 may comprise
providing a base paper PAP1 having a first side and a second side,
applying a pre-coat layer PRE1 on the first side of the base paper PAP1
applying a layer of temperature sensitive coating LEU1 on the first side of the base paper PAP1, thereby forming a thermal paper and
applying a layer of pressure sensitive adhesive ADH1 suitable for flexographic printing with ultraviolet (UV) curable inks on the second side of the base paper PAP1, thereby forming a double-side printable label LAB1. Other layers may be applied on the first side or a second side of the base paper PAP1, if needed.

Thermal printing benefits of good quality paper. The quality of paper suitable for thermal printing may be defined by means of paper brightness, opacity, whiteness, smoothness/roughness and/or surface strength. The base paper PAP1 is therefore typically made of chemical pulp, preferably of bleached chemical pulp. The base paper PAP1 typically has a thickness of 30 micrometres or more, preferably 40 micrometres or more, most preferably 50 micrometres or more, such as in the range of 30 to 60 micrometres, preferably in the range of 40 to 59 micrometres, most preferably in the range of 55 to 58 micrometres. Chemical pulp has a very high cellulose fibre content and thereby excellent physical properties, such as stiffness and rigidity. Bleaching of chemical pulp further decreases the amounts of hemicelluloses, lignin, wood extractives and inorganics in the material considerably. Bleached chemical pulp typically contains lignin in an amount of less than 1 wt.%, preferably less than 0.5 wt.%, most preferably less than 0.2 wt.% of the weight of the base paper PAP1. A base paper PAP1 made of bleached chemical pulp thus enables to produce a label with enhanced surface whiteness and brightness. Advantageously the face side of the label, prior to direct thermal printing, has a ISO whiteness equal to or above 105%, preferably equal to or above 120 %, most preferably equal to or above 130%, when determined in accordance with ISO 11475.

A thermal label LAB1 comprises a temperature sensitive coating LEU1. The temperature sensitive coating LEU1 comprises chemical reagents such as color former, color developer and sensitizing agent. The temperature sensitive coating LEU1 has been configured to melt upon exposure to a sufficient amount of heat, thereby initiating a chemical reaction. The chemical reaction is typically a reduction or oxidation reaction, which is takes place in a molten state between a color former and a color developer and produces a color change. The temperature sensitive coating LEU1 is typically applied on the base paper PAP1 or on a pre-coating layer PRE1 as an aqueous suspension and dried subsequently into a solid layer. The layer of temperature sensitive coating LEU1 typically has a thickness of 2 micrometres or more, such as in the range of 2 to 6 micrometres, preferably in the range of 2 to 5 micrometres, most preferably in the range of 3 to 4 micrometres.

The temperature sensitive coating LEU1 comprises a color former, which may be a leuco dye. Examples of leuco dyes are for example triaryl methane phthalide dyes, fluoran dyes and crystal violet lactone. Often a spirolactone compound is used as a leuco dye. Advantageously a leuco dye suitable for direct thermal printing generally has a five-membered spirolactone ring at one end of the molecule, and a tertiary amino group at another end of the molecule, which facilitates the spirolactone ring opening.

The temperature sensitive coating LEU1 comprises a color developer, which is a weakly acidic compound capable to transfer protons to the color former, thereby triggering the chemical reaction. The color developer is preferably a compound which is stable at the thermal printing temperatures and does not have strong acidity, since strong acidity may promote background imaging. A traditional example of a color developer has been 2,2-bis(p-hydroxyphenyl)propane, also known as 4,4’-isopropylidenediphenol, also known as Bisphenol A. Color developers which are alternative to Bisphenol A are, for example, other bisphenolic color developers, such as Bisphenol S, Bisphenol F, Bisphenol C and their derivatives, wherein the chemical structure has two hydroxyl groups connected to benzene rings, as does BPA. Other types of color developers, such as phenolic developers, which are bisphenol-free, are also possible. Typically the chemical structure of a bisphenol-free color developer has only one hydroxyl group connected to a benzene ring. The color developer may alternatively be a phenol-free developer, such as a zinc salt, a substituted salicylic acid or a compound which is a sulfone and / or urea derivative. An example of a sulfone based color developer is 3,3’-diallyl-4,4’-dihydroxy-diphenyl sulfone. An example of a color developer which is urea derivative is N-(p-Toluenesulfonyl)-N'-(3-ptoluenesulfonyloxyphenyl)urea.

The temperature sensitive coating LEU1 typically comprises one or more sensitizing agents. A sensitizing agent may be used to lower the melting point temperature of the temperature sensitive coating LEU1. The sensitizing agent may thereby facilitate the initiation of the chemical reaction. The sensitizing agent may further act as a temperature-dependent solvent for the color former and the color developer, configured to initiate the chemical reaction upon exposure to sufficient amount of heat. The sensitizing agent may be, for example, a fatty acid amide, a wax or a carboxylic acid ester. Preferably, the sensitizing agent may be an aromatic ether, an aromatic ester, or a biphenyl derivative, which upon direct thermal printing are less prone to develop residue build-up on the thermal printing head.

The temperature sensitive coating LEU1 may further comprise inorganic minerals or fillers, such as precipitated calcium carbonate, calcined kaolin, silica or calcined clay. These compounds, which do not melt in the same manner as the color former, the color developer and/or the sensitizing agent, may therefore be used as binding material to prevent migration of the chemicals participating in the chemical reaction in a melt state. The inorganic minerals or fillers may further be used to increase the whiteness of the face side FLR1.

The thermal label LAB1 may comprise a pre-coat layer PRE1 between the base paper PAP1 and the temperature sensitive coating LEU1. The pre-coat layer PRE1 is applied on the base paper PAP1 prior to the layer of temperature sensitive coating LEU1. The pre-coat layer PRE1 is typically a layer which may be applied as a liquid to provide surface smoothness and uniformity. The pre-coat layer PRE1 may further promote anchorage of the temperature sensitive coating LEU1 towards the base paper PAP1. The pre-coat layer PRE1 may comprise, for example starch and/or polyvinyl alcohol and/or latex, such as styrene butadiene latex (SB) or a styrene acrylic (SA) latex. The pre-coat layer PRE1 may be used as a further heat insulating layer on the face side FLR1 of the label LAB1. The pre-coat layer PRE1 may thus provide insulation between the temperature sensitive coating LEU1 and the layer of pressure sensitive adhesive layer ADH1. The pre-coat layer PRE1 is applied typically in the range of 2-15 g/m², preferably in the range of 5-12 g/m². The pre-coat layer PRE1 may have a thickness of 5 micrometres or more, such as in the range of 5 to 15 micrometres, preferably in the range of 8 to 13 micrometres, most preferably in the range of 9 to 11 micrometres.

The thermal label LAB1 may further comprise a coating layer TOP1 on top of the temperature sensitive coating LEU1 as an outermost layer of the face side FLR1. The coating layer TOP1 is typically colorless and transparent. The coating layer TOP1 may comprise or consist of, for example water-soluble starch, carboxylmethylcellulose, partially or fully hydrolyzed polyvinyl alcohol or a derivative thereof. The outermost layer may be used to protect the temperature sensitive coating LEU1 against mechanical abrasion, chemicals and exposure to surrounding environmental conditions. The coating layer TOP1 is applied typically in the range of 2-4 g/m². The coating layer TOP1 typically has a thickness of 1 micrometres or more, such as in the range of 1 to 4 micrometres, preferably in the range of 1 to 3 micrometres, most preferably in the range of 2 to 3 micrometres.

The thermal label LAB1 may further comprise a barrier layer REV1 between the base paper layer PAP1 and the pressure sensitive adhesive layer ADH1. The barrier layer REV1 may be applied as a coating on the reverse side REV1 and used to prevent migration of the pressure sensitive adhesive through the base paper layer PAP1. The barrier layer REV1 may comprise or consist of water-soluble starch, carboxylmethylcellulose, partially or fully hydrolyzed polyvinyl alcohol or a derivative thereof. The barrier layer REV1 typically has a thickness of 1 micrometres or more, such as in the range of 1 to 4 micrometres, preferably in the range of 1 to 3 micrometres, most preferably in the range of 2 to 3 micrometres.

### Reverse Side Printability

The thermal label LAB1 comprises a layer of pressure sensitive adhesive ADH1 on the reverse side BLR1. The reverse side BLR1 of a double-side printable label LAB1 needs to be suitable for flexographic printing with UV light curable printing inks, which are widely used in the food industry for printing of flexible packages, such as plastic wrappings, corrugated board as well as adhesive label laminates.

Flexographic printing is a mechanical letterpress method which is characterized by a soft and flexible printing plate. UV light curable printing inks are not based on evaporation of a solvent but instead on a polymerization reaction by means of UV light radiation and oxygen, referred to as curing. UV light curable printing inks typically comprise a binder, functional monomers, pigment and additives, such as photoinitiators. Photoinitiators are compounds which contain reactive groups and react to high-energy radiation, thereby starting the polymerization reaction, which is also referred to as curing. A challenge with many of the photoinitiators used in UV light curable printing inks is, that the photoinitiators tend to be highly migrative components. However, compared with conventional printing inks, UV light curable printing inks have the advantage of a very high curing rate, formability, and possess a good resistance to chemicals and scratching. With UV light curable printing inks, the thickness of the printing ink layer is typically in the range of 0.8 to 2.5 micrometres.

The pressure sensitive adhesives suitable for food contact applications appear to provide a means to use a broader variety of UV light curable printing inks for reverse side printing. The pressure sensitive adhesives have many advantageous qualities. The PSA may be applied on the thermal paper by means of a coater. Example methods for applying the PSA are slot, gravure, reverse roll and curtain coating. The coating method may be selected based on the characteristics of the PSA. Preferably, the PSA is of a permanent type, such that the label is not detached prematurely from the product surface. Permanent adhesives have a high tack value. The adhesion strength of a pressure sensitive permanent adhesive towards the surface develops as a function of time, referred to as an adhesive set-up time. For example, a sufficient strength of the bond between the label and the product may be attained almost immediately when pressing, within minutes or within half an hour after the adhesive is brought into contact with the package surface. The adhesive may adhere to the surface at a minimum temperature of -40° C. or higher, such as at a minimum temperature of -20° C. or higher. The adhesive may adhere to the surface at a maximum temperature of 100° C. or lower, such as at a maximum temperature of 80° C. or lower. The adhesive may adhere to the surface, for example in the range of -20° C. to 100° C., or in the range of -40° C. to 60° C. The temperature range wherein the adhesive may adhere to the surface is referred to as the service temperature of the adhesive.

The pressure sensitive adhesive ADH1 may be selected from a group of water-based acrylic adhesives or a hotmelt adhesives that are suitable for use in labelling of food containers. Preferably, the layer of pressure sensitive adhesive is a water-based acrylic adhesive, most preferably a water-based acrylic adhesive, which includes acrylic polymer(s) and tackifying resin(s), such as rosin ester resins. Water-based acrylic PSA adhesives suitable for use in labelling of food containers have been noted to be particularly suitable for reducing thermosensitivity of the reverse side of a double side printable label. The adhesive layer may comprise an elastomer component, such as an acrylic, ethylene-vinyl acetate or a styrene block copolymer. The final adhesive strength may form for example in less than 4 hours of attachment. The adhesive strength may be expressed by a tack value, as described above. The tack value of an adhesive may be determined according to a FINAT test method (9th edition, 2014) for loop tack measurement, referred to as FTM9. The tack value of an adhesive may be determined from a combination of an adhesive layer attached to a label. An adhesive of a permanent type suitable for the label LAB1 may have a tack value of equal to or higher than 10 Newton preferably equal to or higher than 13 Newton, most preferably equal to or higher than 16 Newton. A pressure sensitive adhesive of a permanent type may have a tack value in the range of 10 to 25 Newton, when determined by using FTM9.

The suitability of a pressure sensitive adhesive ADH1 for flexographic printing with ultraviolet curable inks may be further defined by means of the surface free energy of the pressure sensitive adhesive. The surface free energy of PSA may be measured by means of a drop shape analysis. Kruss Drop Shape Analyzer serves as an example of a device suitable for drop shape analysis.

### Print Contrast Signal and Machine Readability of Double Side Printable PSA Label

Reference is made to FIG. 1b. The face side FLR1 of the label LAB1 is intended for direct thermal printing. The thermal print, referred to as product specific data MRK2 in FIG. 1b, is often provided in machine readable format, such as in one-dimensional or two-dimensional bar code format. A linear bar code refers to a one-dimensional specific pattern made up of lines and spaces of various widths. A ladder bar code is an example of a linear bar code, which has been printed in a direction parallel to the propagation of a thermal label during direct thermal printing. Correspondingly, a fence bar code refers to a linear bar code, which is read in a direction perpendicular to the propagation of a thermal label during direct thermal printing. A ladder bar code is more difficult to print sharply. Typically, the bar code is scanned (i.e. machine read) at visible light wavelength in the range of 630 to 650 nm, using a LED light source for illumination.

The verification of a bar code machine readability may be assessed by determining the contrast, resolution and/or defects of the direct thermal print. Advantageously, the quality of print displayed in machine readable format may be evaluated by print contrast signal, denoted as PCS. The machine readability of a label may be may be determined by means of direct thermal printing of a ladder bar code, and evaluating the print contrast signal of the produced ladder bar code in accordance with the standard ISO / IEC 15416:2016(E).

In essence, print contrast refers to the relative reflectance difference between light and dark elements of the produced ladder bar code in percentages, wherein the light elements denote the non-printed regions (i.e. background) and the dark elements denote the thermally printed regions, which have produced a color change. The print contrast signal (PCS) may therefore be expressed according to equation 1 below:

$$\text{PCS=} \left(\text{R1-Rd}\right) / \text{R1} \times \text{100\%}$$

, wherein R1 is the reflectance of a non-printed region and Rd is the reflectance of a thermally printed region.

In practice, a label suitable for machine readable labelling refers to a label wherein the face side is capable to provide a minimum print contrast signal of equal to or higher than 80% at visible light wavelength in the range of 630 to 650 nm, when determined by means of direct thermal printing of a ladder bar code, in accordance with the standard ISO / IEC 15416:2016(E). If the reflection difference is not sufficiently high, the machine readability of the label is inadequate.

### Static Thermosensitivity of Double Side Printable PSA Label

Static thermosensitivity, also known as static sensitivity, defines the temperature at which the color former, such as a leuco dye, and the color developer begin to melt. The static thermosensitivity of a thermal label is a measure of the temperature at which the temperature sensitive coating begins to change color. The darkening phenomenon of the temperature sensitive coating is referred to as ‘direct thermal printing’ or ‘on-line thermal printing’. The static thermosensitivity of a thermal label thus indicates the relationship between temperature and the change of color at the face side of the label. Static thermosensitivity refers to the portion of incident light reflected by the label and may be determined from the face side of the label. The static thermosensitivity of a thermal paper may further be determined independently from the reverse side of the thermal paper. Static thermosensitivity may be expressed as optical density at a defined temperature, typically in the range of 60 to 150° C., such as at a temperature of 80° C. and/or 95° C. The optical density of a surface is preferably determined as an arithmetic mean of three measurements with 45°/0° ring illumination optics, after 2 seconds of exposure. A densitometer, X-Rite eXact Pantone® may be used to determine the optical density of the label and the base paper comprising a layer of temperature sensitive coating. According to the manufacturer’s specification, X-Rite eXact Pantone® is in accordance with the industry standard ISO 5-4:2009(E) for measurement of reflection density characteristics.

A low static thermosensitivity correlates with good contrast of the direct thermal print. In other words, when a thermal label comprises a low optical density value, it serves as an indication that the temperature sensitive coating does not react during a cooling stage of a thermal printing head used in direct thermal printing. Interestingly, experimental results obtained of BPA free thermal labels comprising PSA layers that have been approved for food packaging applications have surprisingly indicated, that a lower static thermosensitivity of the label correlates with reduced tendency of a mirror image of a flexographic print with UV curable inks from appearing on the face side of a the label. Static thermosensitivity can therefore be used as a measure of double-side printability of a PSA label comprising a layer of temperature sensitive coating free of BPA, when the PSA has been approved for food packaging applications. Further, the results indicate that when a layer of such PSA has been applied on the reverse side of the label free of BPA, the thickness of the PSA layer thus formed may be used to adjust the barrier properties of the reverse side of the label towards UV curable printing inks. With respect to the base paper comprising a layer of temperature sensitive coating, preferably, the portion of incident light reflected by the reverse side is less than the portion of incident light reflected by the face side, when expressed as optical density values. Experimental studies of BPA free labels further indicate that optical density of less than 0.1, when determined from the face side of the label, may be used as a predictor of a sufficient PSA layer thickness for double-side printability. Experimental studies of BPA free thermal papers further indicate that optical density of less than 0.1, when determined from the both the face side and the reverse side of the label, may be used as a predictor of a suitability for double-side printable label.

The correlation between low static thermosensitivity and reduced tendency of a mirror image formation of a flexographic print made with UV light curable printing inks of a double-side printable PSA label has been observed to be most prominent when the thickness of the PSA layer on the reverse side is in the range of 10 to 20 micrometres. Further, a water-based acrylic adhesive appears to be more effective, than a hotmelt adhesive. When a hotmelt adhesive is used, the pressure sensitive adhesive layer thickness is preferably in the range of 15 to 20 micrometers. When a water-based acrylic adhesive is used, the pressure sensitive adhesive layer thickness may be 15 micrometres or less, preferably in the range of 10 to 15 micrometers. The thickness of the pressure sensitive adhesive layer may be determined from a sample according to ISO 534, for example by using an instrument designed for this purpose, such as L&W Micrometer.

### Example 1- Effect of PSA to Static Thermosensitivity

In an experimental study, the effect of PSA to the static thermosensitivity of thermal labels was studied. The study consisted of thee samples S1, S2 and S3, each sample comprising the same BPA free thermal paper having a basis weight of 67 g/m² and a thickness of 74 micrometres. Sample S1 was a thermal paper only, without a layer of PSA, and served as a negative control sample for the effect of PSA. Sample S2 was a thermal label, wherein the same thermal paper had been coated with a permanent hot-melt PSA. Sample S3 was a thermal label, wherein the same thermal paper had been coated with a permanent water-based acrylic PSA having a tack value of 18N and which contained approval for labelling of food containers. The water-based acrylic PSA was a dispersion adhesive based on acrylate polymers and tackifying resins, such as rosin ester resins. Sample S2 had a PSA layer thickness of 19 micrometers and sample S3 had a PSA layer thickness of 15 micrometers. The static thermosensitivity of the samples was measured as optical density from the face side of each sample five times (OD_1 to OD_5), using a X-Rite Exact Pantone® densitometer with 45°/0° ring illumination optics, following the manufacturer’s instructions, in accordance with standard ISO 5-4:2009(E). The optical density values were recorded from the samples S1, S2 and S3 after applying UV flexographic printing ink on the reverse side of the samples and curing the UV flexographic printing ink with Flexiproof 100 machine which simulated a flexographic printing, using a 200 W/cm fluorescent lamp having a width of 100 mm, the distance of the light source being 10 mm from the reverse side surface facing the light source, the samples propagating under the lamp at a speed of 50 meters/minute. All of the samples S1, S2 and S3 were thus subjected to the same treatment, the difference in the experimental study thus being in the presence of a PSA layer and its composition.

The results are presented at Table 1 (below).

Table 1. Results of optical density measurements from the face side of samples S1, S2 and S3. OD_1 to OD_5 refer to measured values, OD_AVE refers to the average value of the five measurements in each sample and STDEV refers to the standard deviation between the five measurements.

| | S1 | S2 | S3 |
|---|---|---|---|
| OD_1 | 0,803 | 0,696 | 0,081 |
| OD_2 | 0,925 | 0,623 | 0,082 |
| OD_3 | 0,817 | 0,625 | 0,082 |
| OD_4 | 0,818 | 0,538 | 0,088 |
| OD_5 | 0,891 | 0,603 | 0,087 |
| OD_AVE | 0,851 | 0,617 | 0,084 |
| STDEV | 0,054 | 0,057 | 0,003 |

As demonstrated by the study, the static thermosensitivity, when measured as optical density from sample S3 containing permanent water-based acrylic PSA, was less than 0.1. Further, the optical density of the sample S3 containing permanent water-based acrylic PSA was significantly less than the optical density of the thermal paper alone. Further still, the optical density of the sample S2 containing permanent hotmelt PSA was less than the optical density of the thermal paper alone. Furthermore, the optical density of the sample S3 containing permanent water-based acrylic PSA was significantly less than the optical density of the sample S2. The results indicate that a layer of pressure sensitive adhesive, a water-based acrylic adhesive in particular, may be used for adjusting the thermosensitivity of a thermal label. Based on the results of the experimental study, a water-based acrylic adhesive appears to improve the barrier properties of the thermal label towards UV flexographic printing ink and to enhance the insulating properties of the reverse side of the thermal label, when expressed by the optical density of the label.

The machine readability of the three samples was determined by means of direct thermal printing of a ladder bar code on the labels, after the flexographic print with ultraviolet curable inks had been provided on the reverse side of the labels. The print contrast signal was determined of a ladder bar code produced on the face side of the label, in accordance with the standard ISO / IEC 15416:2016(E). In the tested label S3, the face side was capable to provide a minimum print contrast signal of equal to or above 80% at visible light wavelength in the range of 630 to 650 nm, when determined by means of direct thermal printing of a ladder bar code, in accordance with the standard ISO / IEC 15416:2016(E).

### Example 2 - Static Thermosensitivity Of BPA Free Thermal Labels At 80° C.

In a second experimental study, the static thermosensitivity behavior of BPA free thermal papers was studied by exposing two sets of thermal papers to temperatures ranging from 70° C. to 135° C. The first set comprised two samples, Ex_1 and Ex_2, which each contained a bisphenolic color developer in the temperature sensitive coating. Sample Ex1 contained a Bisphenol S derivative as a color developer in the temperature sensitive coating. Sample Ex_2 contained Bisphenol S as a color developer in the temperature sensitive coating, the grammage of sample Ex2 being 68 g/m². The second set of samples comprised two samples C_1 and C_2, wherein sample C_1 contained a bisphenol-free color developer (3,3’-diallyl-4,4’-dihydroxy-diphenyl sulfone) and sample C_2 contained a phenol-free color developer (N-(p-Toluenesulfonyl)-N'-(3-ptoluenesulfonyloxyphenyl)urea) in the temperature sensitive coating.

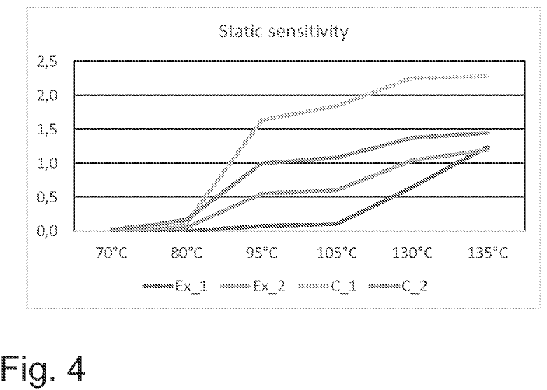

The static thermosensitivity was measured as optical density from each sample as an arithmetic mean of three measurements from both the reverse side and the face side. X-Rite Exact Pantone® densitometer with 45°/0° ring illumination optics was used, following the manufacturer’s instructions, in accordance with standard ISO 5-4:2009(E). The optical density values were recorded after 2 seconds of exposure at temperatures of 70° C., 80° C., 95° C., 105° C., 130° C. and 135° C. The selected temperature range may be used to determine the temperature-dependent change of optical density, which is a measure of the portion of incident light reflected by the face side and by the reverse side of the thermal paper. The results of the experimental study are presented at Table 2 (below) and illustrated in FIG. 4.

Table 2. Results of optical density (O.D.) measurements of two sets of samples at temperatures in the range of 70 to 135° C. The optical density (O.D.) values presented for each sample are arithmetical mean values calculated from 6 measurements, of which three have been made from the face side and 3 from the reverse side.

| Temperature | O.D. Ex_1 | O.D. Ex_2 | O.D. C_1 | O.D. C_2 |
|---|---|---|---|---|
| 70° C. | 0.005 | 0.008 | 0.023 | 0.007 |
| 80° C. | 0.001 | 0.043 | 0.121 | 0.162 |
| 95° C. | 0.073 | 0.550 | 1.632 | 0.991 |
| 105° C. | 0.096 | 0.601 | 1.844 | 1.081 |
| 130° C. | 0.642 | 1.036 | 2.252 | 1.370 |
| 135° C. | 1.231 | 1.197 | 2.275 | 1.439 |

Referring to FIG. 4 and Tables 2 and 1 (above). The results demonstrate that the optical density (O.D.), when determined from each side of a base paper comprising a layer of temperature sensitive coating as an arithmetic mean of three measurements with 45°/0° ring illumination optics, after 2 seconds of exposure at a temperature of 80° C., in accordance with standard ISO 5-4:2009(E), serves as an indicator of the temperature dependent behavior of the base paper comprising a layer of temperature sensitive coating. Further, the optical density (O.D.) may be used as an indicator of the temperature dependent behavior of the double-side printable label. When the mean optical density, at a temperature of 80° C., was equal to or less than 0.1, the base paper comprising a layer of temperature sensitive coating demonstrated significantly lower static thermosensitivity throughout the measured temperature range. The differential development of the mean optical density between the first set and the second set of samples was particularly evident at a temperature of 95° C., wherein the mean optical density of the first set of samples was less than 0.7, while in the second set of samples the mean optical density was significantly higher. When combined to the results of Example 1, it was contemplated, that a bisphenolic color developer, Bisphenol S and/or its derivatives in particular, together with a permanent water-based acrylic PSA having a tack value of 18N and which contained approval for labelling of food containers, is an advantageous combination in a double-side printable label to obtain low static thermosensitivity and to improve the barrier properties of the thermal label towards UV flexographic printing ink on the reverse side of the label. The lower static thermosensitivity on the reverse side of these base papers comprising a layer of temperature sensitive coating was also observed to correlate with reduced tendency of a mirror image of a flexographic print made with UV light curable printing ink appearing on the face side of the thermal labels.

As a general conclusion of the studies above, pressure sensitive adhesive layer on the reverse side therefore displayed a means to control the properties of thermal labels, such that the appearance of a reverse side print on the layer of temperature sensitive coating on the face side was avoidable. Further, the selection of the pressure sensitive adhesive and the base paper comprising a layer of temperature sensitive coating provided means to produce labels with reduced tendency of a mirror image of a flexographic print made with UV light curable printing ink appearing on the face side of the thermal labels.

While the mean optical density measurements of the base paper comprising a layer of temperature sensitive coating at a temperature of 80° C. was higher than 0.1 in the second set of samples C_1 and C_2, comprising a bisphenol-free color developer or a phenol-free color developer, it was contemplated that by increasing the thickness of the pressure sensitive adhesive layer, the interaction with the temperature sensitive coating could be reduced. The results indicate that by selecting the composition and/or the thickness of the pressure sensitive adhesive layer, the interaction with the temperature sensitive coating may be reduced.

### Example 3 - Surface Free Energy of BPA Free Thermal Labels

In a third experimental study, thermal labels comprising a layer of hotmelt PSA were compared to thermal labels comprising water-based acrylic PSA in respect of the surface free energy of the layer of PSA. The study consisted of four samples, of which samples S2 and S3 were the same as in Example 1 (above). Sample S4 was another example of a thermal label comprising water-based acrylic PSA and sample S5 was another example of a thermal label comprising hotmelt PSA.

The surface free energy of each sample was measured with a Kruss Drop Shape Analyzer. The measurement was conducted on the layer of PSA of each thermal label by means of a sessile drop method at room temperature, wherein a drop of standard test solution of diiodomethane was deposited on the surface of the PSA layer and the static contact angle of the drop was determined, after the sessile drop formed on the surface. In the study, a 4 second waiting time was used for the sessile drop. From the determined static contact angle, the surface free energy, including the polar and disperse interaction fractions, were calculated in accordance with the Wu model (harmonic mean) and the Owens-Wendt-Rabel-Kaelben (OWRK) model (geometric mean). To improve the accuracy of the drop shape analysis, the determination was repeated 10 times. Thus, in total 10 drops were deposited at different locations of the PSA layer, from which the surface free energy was determined as an arithmetical mean value.

Table 3 (below) presents the determined surface free energy values of PSA layers in samples S2, S3, S4 and S5 in unit of milliNewton per meter (mN/m).

Table 3. Surface free energy values (mN/m) determined by sessile drop method from samples S2, S3, S4 and S5 after 4 seconds.

| | | Wu | OWRK | STDEV |
|---|---|---|---|---|
| Hotmelt PSA (S5) | Surface free energy | 26,0 | 23,9 | 1,3 |
| | Disperse | 26,5 | 23,9 | 1,3 |
| | Polar | -0,5 | 0,0 | 0,0 |
| Hotmelt PSA (S2) | Surface free energy | 27,2 | 25,3 | 0,6 |
| | Disperse | 27,7 | 25,3 | 0,6 |
| | Polar | -0,5 | 0,0 | 0,0 |
| Water-based acrylic PSA (S3) | Surface free energy | 20,0 | 14,2 | 1,9 |
| | Disperse | 17,3 | 13,1 | 1,1 |
| | Polar | 2,8 | 1,2 | 0,8 |
| Water-based acrylic PSA (S4) | Surface free energy | 15,4 | 10,5 | 1,2 |
| | Disperse | 14,6 | 10,2 | 1,0 |
| | Polar | 0,8 | 0,3 | 0,2 |

The experimental study demonstrates a clear difference in the behavior of the thermal labels comprising a layer of hotmelt PSA (samples S2 and S5) to those comprising water-based acrylic PSA (samples S3 and S4). The surface free energy of thermal labels comprising a layer of water-based acrylic PSA is significantly lower. It was further observed, that the water-based acrylic PSA appeared to repel the standard test solution more than the hotmelt PSA. Interestingly, sample S3, comprising the same water-based acrylic PSA, was used in both examples 1 and 3. The results together therefore indicate that thermal labels comprising a layer of water-based acrylic PSA may have an improved barrier effect towards UV light curable printing inks, which typically contain higher amounts of pigments. A layer of water-based acrylic adhesive may further possess a better retention capability of UV light curable printing inks, which can be evidenced by measuring the optical density of the label.

1. A double-side printable label (LAB1) suitable for machine readable labelling of food containers, the label (LAB1) comprising
a base paper (PAP1) made of chemical pulp that separates
a face side (FLR1) suitable for direct thermal printing and
◯ a reverse side (BLR1),
the reverse side (BLR1) comprising a layer of pressure sensitive adhesive (ADH1), which layer is suitable for flexographic printing with ultraviolet curable inks, and,
the face side (FLR1) comprising a layer of temperature sensitive coating (LEU1) which is free of 2,2-bis(p-hydroxyphenyl)propane, and
wherein the pressure sensitive adhesive (ADH1) layer thickness (Hₐ) has been selected such that the portion of incident light reflected by the face side (FLR1) of the label (LAB1), when expressed as optical density, is less than 0.1, when determined as an arithmetic mean of three measurements with 45°/0° ring illumination optics, after 2 seconds of exposure at a temperature of 80° C.

2. (canceled)

3. The double-side printable label (LAB1) according to claim 1 ,wherein the pressure sensitive adhesive (ADH1) layer thickness (Hₐ) is in the range of 10 to 20 micrometers.

4. The double-side printable label (LAB1) according to claim 1 , wherein the temperature sensitive coating (LEU1) contains a color former, color developer and a sensitizing agent.

5. The double-side printable label (LAB1) according to claim 1 , wherein the color developer is a bisphenolic color developer, such as Bisphenol S, Bisphenol F or Bisphenol C.

6. The double-side printable label (LAB1) according to claim 3 or 4, wherein the color developer is Bisphenol S or its derivative.

7. The double-side printable label (LAB1) according to claim 1, wherein the portion of incident light reflected by the face side (FLR1) of the label (LAB1), when expressed as optical density, is less than 0.7, when determined as an arithmetic mean of three measurements with 45°/0° ring illumination optics, after 2 seconds of exposure at a temperature of 95° C.

8. The double-side printable label (LAB1) according to claim 1, wherein the base paper (PAP1) comprising a layer of temperature sensitive coating (LEU1) has been selected such that the portion of incident light reflected by the reverse side (BLR1) of the base paper (PAP1) is less than the portion of incident light reflected by the face side (FLR1) of the base paper (PAP1) comprising the layer of temperature sensitive coating (LEU1), when expressed as optical density values determined as an arithmetic mean of three measurements with 45°/0° ring illumination optics, after 2 seconds of exposure at a temperature of 80° C. or 95° C.

9. The double-side printable label (LAB1) according to claim 1, wherein the layer of pressure sensitive adhesive (ADH1) is claim 1, permanent adhesive having a loop tack value which is equal to or higher than 10 Newton, when measured according to FINAT test method no. 9 (9th edition, 2009).

10. The double-side printable label (LAB1) according to claim 1, wherein the pressure sensitive adhesive (ADH1) is a water-based acrylic adhesive.

11. The double-side printable label (LAB1) according to claim 1, further comprising barrier layer (REV1) between the base paper layer (PAP1) and the pressure sensitive adhesive layer (ADH1) comprising or consisting of water-soluble starch, carboxylmethylcellulose, partially or fully hydrolyzed polyvinyl alcohol or a derivative thereof.

12. The double-side printable label (LAB1) according to claim 1, further comprising a coating layer (TOP1) on top of the temperature sensitive coating (LEU1) as an outermost layer of the face side (FLR1), the coating layer (TOP1) comprising or consisting of water-soluble starch, carboxylmethylcellulose, partially or fully hydrolyzed polyvinyl alcohol or a derivative thereof.

13. The double-side printable label (LAB1) according to claim 1, further comprising a precoating layer (PRE1) between the base paper (PAP1) and the temperature sensitive coating (LEU1).

14. The double-side printable label (LAB1) according to claim 1, wherein the base paper (PAP1) has a lignin content of the chemical pulp is less than 0.5 wt.%.

15. The double-side printable label (LAB1) according to claim 1, wherein after UV flexographic printing of the reverse side (BLR1), the face side (FLR1) is capable to provide a minimum print contrast signal of equal to or above 80% at visible light wavelength in the range of 630 to 650 nm, when determined by means of direct thermal printing of a ladder bar code, in accordance with the standard ISO / IEC 15416:2016(E).

16. The double-side printable label (LAB1) according to claim 1, wherein the face side (FLR1), prior to direct thermal printing, has a CIE whiteness equal to or above 105 %, preferably equal to or above 120 %, most preferably equal to or above 130 %, when determined in accordance with ISO 11475.

17. A method for manufacturing a double-side printable label (LAB1) suitable for machine readable labelling of food containers, the method comprising
providing a base paper (PAP1) made of chemical pulp, which comprises a layer of temperature sensitive coating (LEU1) which is free of 2,2-bis(p-hydroxyphenyl)propane and a priming layer (PRE1) between the base paper layer (PAP1) and the layer of temperature sensitive coating (LEU1) on a first side of the base paper (PAP1), thereby obtaining a face side (FLR1) suitable for direct thermal printing,
coating pressure sensitive adhesive which is suitable for UV flexographic printing onto the other side of the base paper (PAP1), thereby obtaining a reverse side (BLR1) comprising a layer of pressure sensitive adhesive (ADH1),
wherein the method, the thickness (Hₐ) of the layer of pressure sensitive adhesive (ADH1) is selected such that the portion of incident light reflected by the face side (FLR1) of the label (LAB1), when expressed as optical density, is less than 0.1, when determined as an arithmetic mean of three measurements with 45°/0° ring illumination optics, after 2 seconds of exposure at a temperature of 80° C.

18. The method according to claim 17, wherein the pressure sensitive adhesive (ADH1) layer thickness (Hₐ) is in the range of 10 to 20 micrometers.

19. The method according to claim 17, wherein the temperature sensitive coating (LEU1) contains a color former, color developer and a sensitizing agent, and wherein the color developer is a bisphenolic color developer, such as Bisphenol S, Bisphenol F or Bisphenol C.

20. The method according to claim 17, wherein
the pressure sensitive adhesive (ADH1) is a water-based acrylic adhesive or
the double-side printable label (LAB1) further comprising barrier layer (REV1) between the base paper layer (PAP1) and the pressure sensitive adhesive layer (ADH1) comprising or consisting of water-soluble starch, carboxylmethylcellulose, partially or fully hydrolyzed polyvinyl alcohol or a derivative thereof.

21. The method according to claim 17, further comprising a coating layer (TOP1) on top of the temperature sensitive coating (LEU1) as an outermost layer of the face side (FLR1), the coating layer (TOP1) comprising or consisting of water-soluble starch, carboxylmethylcellulose, partially or fully hydrolyzed polyvinyl alcohol or a derivative thereof.
